(19) United States
(12) Patent Application Publication
(10) Pub. No.: US 2020/0192667 A1
(43) Pub. Date: Jun. 18, 2020

(54) ARITHMETIC PROCESSING DEVICE, AND CONTROL METHOD FOR ARITHMETIC PROCESSING DEVICE

(71) Applicant: FUJITSU LIMITED, Kawasaki-shi (JP)

(72) Inventor: Hiroyuki Ishii, Kawasaki (JP)

(73) Assignee: FUJITSU LIMITED, Kawasaki-shi (JP)

(21) Appl. No.: 16/697,256

(22) Filed: Nov. 27, 2019

(30) Foreign Application Priority Data
Dec. 12, 2018 (JP) 2018-232690

(51) Int. Cl. G06F 9/30; G06F 9/38

(52) U.S. Cl. CPC G06F 9/30079; G06F 9/3001; G06F 9/3867; G06F 9/3016

(57) ABSTRACT

An instruction control circuit decodes an instruction and issues a request. A cache control pipeline determines whether or not the requests output from local request ports, an external request port, and an order port are processable. When the request is not processable, then the cache control pipeline performs end processing that includes aborting the request and requesting other request to another request port among the plurality of request ports except the request port which output the request which is not processable for re-output. When a request is processable, then the cache control pipeline performs pipeline processing that includes the requested processing according to the request. A processing sequence adjusting circuit makes the cache control pipeline perform the end processing with respect to a subsequent request which is output after a possible request from the request port that has already output the possible request with respect to which the control pipeline performed the requested processing.

### CROSS-REFERENCE TO RELATED APPLICATION

This application is based upon and claims the benefit of priority of the prior Japanese Patent Application No. 2018-232690, filed on Dec. 12, 2018, the entire contents of which are incorporated herein by reference.

### FIELD

The embodiment discussed herein is related to an arithmetic processing device and a control method for the arithmetic processing device.

### BACKGROUND

A processor such as a central processing unit (CPU) includes a plurality of CPU cores that perform arithmetic processing. In the following explanation, a CPU core is simply referred to as a “core”. Moreover, a processor includes a plurality of levels of cache for the purpose of enhancing the memory access performance. Each core dedicatedly uses a first-level cache called L1 cache (Level 1 cache) that is individually assigned thereto. Moreover, the processor includes higher levels of cache that are shared among the cores. Of the higher levels of cache, the highest level of cache is called the last level cache (LLC).

Moreover, the processor is partitioned into clusters each of which includes a plurality of cores and the LLC. Each cluster is connected to the other clusters by an on-chip network. Moreover, among the clusters, cache coherency is maintained with a directory table that indicates the takeout of data held by each cluster. The directory table represents a directory resource for recording the state of inter-cluster cache takeout.

Moreover, the on-chip network is connected to a chipset interface that represents a low-speed bus which is slow against the operation clock of the processor. The chipset interface has a space in which reading and writing with respect to the cores can be performed using non-cacheable accesses. Apart from that, an interconnect for establishing connection among processors and a PCIe bus (PCIe stands for Peripheral Component Interconnect Express) for establishing connection with PCI devices (PCI stands for Peripheral Component Interconnect) are connected to the on-chip network.

The requests that are output from the cores are temporarily held in request ports; and, after one of the requests is selected via priority circuits installed in between the cores and in between the ports, the selected request is inserted into a cache control pipeline.

The cache control pipeline determines whether the inserted request competes against the address of the request being currently processed; determines the processing details of the request; and performs resource determination about whether or not the circuit resources of the processing unit can be acquired. Then, regarding appropriate requests, the cache control pipeline requests a request processing circuit of a request processing unit to process the requests.

In case it is difficult to start the processing of a request inserted from a request port due to the competition for the address or due to the unavailability of circuit resources, the cache control pipeline aborts the request and returns it to the request port. Thus, for example, until the already-started processing of the request having the competing address is completed, the other requests are aborted in a repeated manner. However, such requests in the request port which have different addresses can be processed by surpassing the aborted requests.

As a processing method for processing such requests, a conventional technology is known in which a request for which the resources are unavailable is retrieved from the pipeline and is again inserted in the pipeline via a circuit, which controls the order of insertion, as and when the resources become available after a waiting period. Moreover, a conventional technology is known in which, when the subsequent request of a request source has the same access line, the access information of the previous request is used; and the right of use of the cache directory, which holds the line addresses, is given to other request sources.

Patent Document 1: Japanese Laid-open Patent Publication No. 07-73035

Patent Document 2: Japanese Laid-open Patent Publication No. 64-3755

However, in the conventional processor, the request for which the resources of the request processing unit could be initially acquired is processed. When the request is able to obtain the resources, the request is processable. Hence, when different requests having the same address compete for resource acquisition, the request which is able to obtain the resources at the timing of being inserted in the control pipeline gets processed, and there is a risk that that a particular request fails in acquiring the resources and gets aborted in a repeated manner. On the other hand, there are times when some other request acquires the resources in a timely manner and thus gets processed. As a result, there is a risk of disparity occurring among the request sources or disparity occurring in the progress of processing among the requests.

Moreover, such disparity in the processing may occur also in the competition of other resources managed using pipelines for virtual-channel buffer resources in the on-chip network.

In that regard, in the conventional technology in which, when the resources become available, the order of insertion is controlled and the request removed from the pipeline is again inserted in the pipeline; there is no guarantee that the resources can be secured and some of the requests are not processed promptly, thereby making it difficult to achieve balance in the processing of the requests. Moreover, in the conventional technology in which, when the subsequent request of a request source has the same access line, the right of use of the cache directory is given to other request sources; there are times when the requests that are lagging behind in being processed are not given priority for processing, thereby making it difficult to achieve balance in the processing of the requests.

### SUMMARY

According to an aspect of an embodiment, an arithmetic processing device includes: an instruction control circuit that decodes an instruction and issues a request; a plurality of request ports each of which receives and outputs the request; a control pipeline that determines whether or not the request output from each of the request ports is processable, when the request is not processable, performs end processing which includes aborting the request and requesting other request to another request port among the plurality of request ports except the request port which output the request which is not processable, and when the request is processable, performs pipeline processing which includes requested processing according to the request; and a sequence adjusting circuit that makes the control pipeline perform the end processing with respect to the request which is output after a processable request from the request port that has already output the processable request with respect to which the control pipeline performed the requested processing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a central processing unit (CPU) according to an embodiment;

FIG. 2 is an exemplary circuit diagram of a last level cache (LLC);

FIG. 3 is a block diagram of a processing sequence adjusting circuit;

FIG. 4 is a diagram in which the held information in the processing sequence adjusting circuit is compiled;

FIG. 5 is a flowchart for explaining a processing-start operation performed at the time of insertion of a request;

FIG. 6 is a flowchart for explaining an initial registration operation;

FIG. 7 is a flowchart for explaining an address match enabled-state information setting operation;

FIG. 8 is a flowchart for explaining subsequent-request processing;

FIG. 9 is a flowchart for explaining an external request enable flag setting operation;

FIG. 10 is a flowchart for explaining the operations performed at the completion of pipeline processing;

FIG. 11 is a flowchart for explaining an address match enabled-state information resetting operation;

FIG. 12 is a sequence diagram illustrating an example of the data processing performed in a conventional CPU; and

FIG. 13 is a sequence diagram illustrating an example of the data processing performed in the CPU according to the embodiment.

### DESCRIPTION OF EMBODIMENT

Preferred embodiments of the present invention will be explained with reference to accompanying drawings. However, the arithmetic processing device and the control method for the arithmetic processing device disclosed in the application concerned are not limited by the embodiment described below.

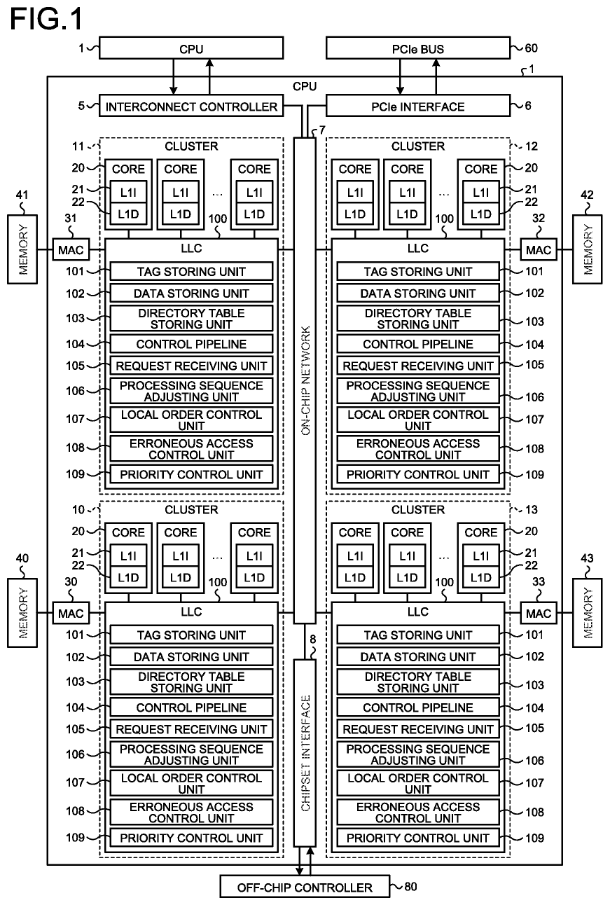

FIG. 1 is a block diagram of a CPU according to the embodiment. A CPU 1 representing the arithmetic processing device includes a command control unit (not illustrated) that decodes instructions and issues arithmetic processing requests; an arithmetic processing circuit (not illustrated); and a plurality of cores 20 each of which includes an L1 instruction cache 21 and an L1 data cache 22. The cores 20 represent examples of an “arithmetic processing unit”. In FIG. 1, each L1 instruction cache 21 and each L1 data cache 22 are expressed as L1I and L1D, respectively. Meanwhile, the cores 20 perform arithmetic processing.

Moreover, in the CPU 1, the cores 20 are divided into a plurality of clusters 10 to 13. Each of the clusters 10 to 13 includes a last level cache (LLC) 100. The clusters 10 to 13 represent examples of an “arithmetic processing group”. Since the clusters 10 to 13 have identical functions, the following explanation is given with reference to only the cluster 10.

The cores 20 belonging to the cluster 10 share the LLC 100 belonging to the cluster 10. Thus, the cluster 10 is an arithmetic processing block including a plurality of cores 20 and a single LLC 100 that is shared by the cores 20.

The LLC 100 includes a tag storing unit 101, a data storing unit 102, a directory table storing unit 103, a control pipeline 104, a request receiving unit 105, a processing sequence adjusting unit 106, a local order control unit 107, an erroneous access control unit 108, and a priority control unit 109. The LLC 100 is connected to a memory access controller (MAC) 30.

When there occurs a cache miss regarding the data for which a request is issued, the LLC 100 requests the MAC 30 to obtain the data. Then, the LLC 100 obtains the data, which is read by the MAC 30 from the memory 40. With respect to the data that is stored in the memory 40 connected via the MAC 30, the LLC 100 is sometimes called the “home” LLC 100.

The tag storing unit 101 is used to store tag data such as significant bits, addresses, and states. The data storing unit 102 is used to store data in the addresses specified in the tag data.

The directory table storing unit 103 is used to store an directory table that indicates the current locations of the data stored in the memory 40 of the home LLC 100. In other words, the directory table storing unit 103 is used to store directory resources meant for recording the takeout state of data among the clusters 10 to 13. The directory resources are used in performing cache coherency control.

The request receiving unit 105 has a port for receiving local requests issued from the cores 20. Moreover, the request receiving unit 105 has a port that, when the LLC 100 of the cluster 10 is the home LLC 100, receives, from the control pipeline 104 of the LLC 100 of the other clusters 11 to 13, external requests meant for requesting transmission of data managed in the home LLC 100. Furthermore, the request receiving unit 105 has a port that, when the LLC 100 of the cluster 10 holds data corresponding to the home clusters 11 to 13, receives, from the home clusters of the data, transfer requests called orders for transferring the data to the other clusters 11 to 13. The external requests and the orders represent examples of an “other-group request”.

The request receiving unit 105 receives local requests, external requests, and orders. Then, while holding the local requests, the external requests, and the orders; the request receiving unit 105 also outputs them to the priority control unit 109. Subsequently, when a completion response is received with respect to a local request, or an external request, or an order; the request receiving unit 105 aborts the corresponding held information.

When a plurality of local requests, external requests, and orders is obtained from the request receiving unit 105, the priority control unit 109 selects one of those requests as the processing target. In the following explanation, when local requests, external requests, and orders need not be distinguished from each other, they are simply referred to as “requests”. The priority control unit 109 inserts the selected request into the control pipeline 104.

The control pipeline 104 performs pipeline processing of each request inserted by the priority control unit 109. The pipeline processing has a plurality of processing stages, and each processing stage is sometimes called a stage. For example, the control pipeline 104 performs pipeline processing in stages 0 to n. In that case, the processing in the stage 0 represents the processing performed at the point of time of insertion of the request. The processing in the stage n represents the processing at the point of time of outputting a processing response upon completion of the pipeline processing.

For example, when a local request is inserted in the control pipeline 104, the LLC 100 of the cluster 10 notifies the erroneous access control unit 108 and the local order control unit 107 about the address and instructs them to perform abort determination.

Moreover, in parallel to the abort determination performed by the erroneous access control unit 108, the control pipeline 104 searches the tag storing unit 101. If the tag data matching with the local request is present in the tag storing unit 101, then the control pipeline 104 determines that a cache hit has occurred. Then, the control pipeline 104 obtains, from the data storing unit 102, data indicated by the tag data. Subsequently, the control pipeline 104 outputs the obtained data to the source of the local request. Moreover, the control pipeline 104 notifies the request receiving unit 105 about the completion of processing of the local request.

Meanwhile, when an instruction for abort processing is received from the erroneous access control unit 108 or the local order control unit 107, the control pipeline 104 aborts the inserted local request and outputs an abort notification to the request receiving unit 105. On the other hand, as a result of checking the directory table storing unit 103, when it is determined that the data is not present in the LLC 100 of the cluster 10; then the control pipeline 104 obtains, from the directory table storing unit 103, such clusters from among the clusters 11 to 13 which possess the data at that point of time and sends an order to the obtained clusters.

Meanwhile, when the tag data matching with the local request is not present in the tag storing unit 101, then the control pipeline 104 determines that a cache miss has occurred. Subsequently, the control pipeline 104 stores the address in the erroneous access control unit 108 and outputs a data acquisition request to the MAC 30. After obtaining the data from the MAC 30, the control pipeline 104 stores the obtained data in the data storing unit 102 and stores the tag data, which indicates the stored data, in the tag storing unit 101. Moreover, the control pipeline 104 outputs the obtained data to the source of the local request. Furthermore, the control pipeline 104 notifies the request receiving unit 105 about the completion of processing of the local request.

When the LLC 100 of the cluster 10 is not the home LLC for the data indicated by the request; then the control pipeline 104 sends, via an on-chip network 7, an external request to the cluster, from among the clusters 11 to 13, representing the home cluster for the data. Subsequently, the control pipeline 104 receives the input of data from the source of the external request via the on-chip network 7. Then, the control pipeline 104 notifies the request receiving unit 105 about the completion of processing.

Meanwhile, when the inserted request is an external request, then the control pipeline 104 processes the external request in an identical manner to a local request while treating another cluster, from among the clusters 11 to 13, as the source of the request. In that case, the control pipeline 104 sends the obtained data to the source cluster, from among the clusters 11 to 13, of the request using a response called request complete. At that time, the control pipeline 104 registers the destination of the data in the directory table stored in the directory table storing unit 103, and thus updates the directory table.

Meanwhile, when the inserted request is an order, then the control pipeline 104 notifies the local order control unit 107 about the address, and makes it perform abort determination. Upon receiving the instruction for abort processing from the local order control unit 107, the control pipeline 104 aborts the inserted order and outputs an abort notification to the request receiving unit 105. On the other hand, when an instruction for abort processing is not received from the local order control unit 107, then the control pipeline 104 sends the data held therein to the other cluster, from among the clusters 11 to 13, which is specified in the order via the on-chip network 7. Subsequently, the control pipeline 104 notifies the request receiving unit 105 about the completion of processing.

When the request is an instruction to be sent to another CPU 1 via an interconnect controller 5 or is an instruction to be sent to a PCIe bus 60 via a PCIe interface 6, then the control pipeline 104 sends the request to the on-chip network 7. In practice, the transmission of the request to another CPU 1 is performed according to the direct memory access (DMA) transfer in which reading and writing of data is directly performed with respect to the memory 40.

In that case, the control pipeline 104 packetizes the request and issues it to the on-chip network 7. When the request is an instruction to be sent to another CPU 1 via the interconnect controller 5 or is an instruction to be sent to the PCIe bus 60 via the PCIe interface 6, then the delay with respect to the operation clock of the CPU 1 is not is not so large. Moreover, such requests are non-cacheable (NC) requests that are not stored in the cache. In the following explanation, a request that is an instruction to be sent to another CPU 1 via the interconnect controller 5 or an instruction to be sent to the PCIe bus 60 via the PCIe interface 6 is called a “typical NC request”. When the buffer for typical NC requests in the interconnect controller 5 or the PCIe interface 6 gets full, the control pipeline 104 performs abort processing with respect to subsequent typical NC requests until space becomes available in the buffer.

Meanwhile, When the request is an instruction to be sent to an off-chip controller 80, then the control pipeline 104 sends the request to the off-chip controller 80 via the on-chip network 7 and a chipset interface (IF) 8. The bus that connects the chipset IF 8 to the off-chip controller 80 is slow against the operation clock of the CPU 1. Moreover, the instruction is a non-cacheable request not stored in the cache. In the following explanation, a request that is an instruction to be sent to the off-chip controller 80 is called a “low-speed NC request”. For example, a low-speed NC request is an instruction issued with respect to frames or the security memory. When the buffer for low-speed NC requests in the chipset IF 8 (described later) becomes full, the control pipeline 104 performs abort processing with respect to subsequent low-speed NC requests until space becomes available in the buffer. The typical NC requests and the low-speed NC requests are examples of a “request that is transferred to another processing mechanism via the control pipeline and gets processed in the other processing mechanism”.

Meanwhile, when a mandatory abort instruction with respect to the inserted request is received from the processing sequence adjusting unit 106, the control pipeline 104 aborts the request regardless of the state of the request and outputs an abort notification to the request receiving unit 105.

When a request is a storage request, the control pipeline 104 sends a data storage request to the MAC 30. Then, until the data storage is completed, the control pipeline 104 holds the address specified in the request. Subsequently, the control pipeline 104 performs abort processing with respect to the storage request corresponding to the same address. When a notification of data storage completion is received from the MAC 30, the control pipeline 104 releases the held address.

With respect to a request output by any core 20 or with respect to a request triggered by an external request or an order issued to any core 20 under the LLC 100, the local order control unit 107 holds an order-processing-issued address. When the address specified either in a new request output from any core 20, or in an external request, or in an order matches with the held address; then the local order control unit 107 makes the control pipeline 104 perform abort processing of that request.

The erroneous access control unit 108 holds the address of each cache miss. When a request output from any core 20 matches with a held address, the erroneous access control unit 108 makes the control pipeline 104 perform abort processing of that request. When the control pipeline 104 obtains, from the MAC 30, the data for which a cache miss has occurred; the erroneous access control unit 108 receives a notification from the control pipeline 104 and releases the held address.

The processing sequence adjusting unit 106 receives input of the information about each request inserted in the control pipeline 104. Then, the processing sequence adjusting unit 106 performs abort determination of the inserted request. When it is determined to abort the request, the processing sequence adjusting unit 106 outputs a mandatory abort instruction to the control pipeline 104. Regarding the abort determination performed by the processing sequence adjusting unit 106, the detailed explanation is given later.

The MACs 30 to 33 receive data acquisition requests from the control pipeline 104 and read specified data from the memories 40 to 43, respectively. Then, the MACs 30 to 33 send the read data to the control pipeline 104.

The MACs 30 to 33 receive data storage requests from the control pipeline 104 and store the data in the specified addresses in the memories 40 to 43, respectively. When the data storage is completed, the Macs 30 to 33 outputs a notification of data storage completion to the control pipeline 104.

The on-chip network 7 has the following components connected thereto: the LLC 100 of the clusters 10 to 13, the interconnect controller 5, the PCIe interface 6, and the chipset IF 8. The on-chip network 7 includes virtual channels (VCs) that are classified according to a plurality of message classes. Examples of the virtual networks include an external request VC, an order VC, a request complete VC, an order complete VC, a typical NC request VC, and a low-speed NC request VC. The typical NC request VC and the low-speed NC request VC are virtual networks for non-cacheable accesses. The low-speed NC request VC is a virtual channel for requests targeted toward the chipset IF 8 that is an off-chip low-speed bus; and the other memory-mapped registers are transferred using the typical NC request VC. Thus, even if the low-speed NC request VC stays on the low-speed bus, the separation of the typical NC request VC enables the control pipeline 104 to issue new requests to the typical NC request VC. Inside the on-chip network 7, a buffer is present for each virtual channel, and the resource count management of the buffers is performed by the control pipeline 104 that is the issuer of the requests.

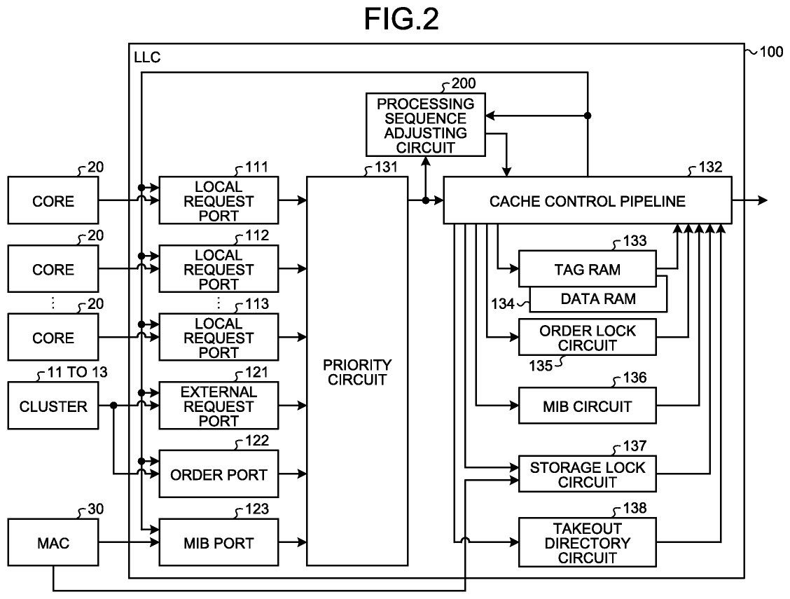

FIG. 2 is an exemplary circuit diagram of the LLC. As illustrated in FIG. 2, the LLC 100 includes local request ports 111 to 113, an external request port 121, an order port 122, and a move in buffer (MIB) port 123. Moreover, the LLC 100 includes a priority circuit 131, a cache control pipeline 132, a tag random access memory (RAM) 133, a data RAM 134, an order lock circuit 135, an MIB circuit 136, a storage lock circuit 137, and a takeout directory circuit 138.

The local request ports 111 to 113, the external request port 121, the order port 122, and the MIB port 123 implement the functions of the request receiving unit 105 illustrated in FIG. 1. The local request ports 111 to 113, the external request port 121, and the order port 122 represent examples of a “request port”.

The local request ports 111 to 113 are all connected to different cores 20. The local request ports 111 to 113 are meant for receiving input of local requests. In the following explanation, when the local request ports 111 to 113 need not be distinguished from each other, they are referred to as local request ports 110.

The external request port 121 and the order port 122 are connected to the other clusters 11 to 13 via the on-chip network 7. However, in FIG. 2, the on-chip network 7 is not illustrated. The external request port 121 is meant for receiving input of external requests sent by the other clusters 11 to 13. The order port 122 is meant for receiving input of order requests sent by the other clusters 11 to 13.

The MIB port 123 is connected to the MAC 30. The MIB port 123 is meant for receiving input of the data read by the MAC 30 from the memory 40.

The priority circuit 131 implements the functions of the priority control unit 109 illustrated in FIG. 1. The priority circuit 131 selects one of the requests input from the local request ports 111 to 113, the external request port 121, the order port 122, and the MIB port 123; and inserts the selected request into the cache control pipeline 132.

The cache control pipeline 132 implements the functions of the control pipeline 104 illustrated in FIG. 1. The cache control pipeline 132 performs pipeline processing in the stage 0 from among the stages 0 to n. The cache control pipeline 132 processes a request, which is inserted from the priority circuit 131 in the stage 0, using the tag RAM 133, the data RAM 134, the order lock circuit 135, the MIB circuit 136, the storage lock circuit 137, and the takeout directory circuit 138. Moreover, the cache control pipeline 132 notifies a processing sequence adjusting circuit 200 and the request port representing the request source about a processing response regarding the request that has been completely processed in the stage n. Moreover, when a mandatory abort instruction is received from the processing sequence adjusting circuit 200, the cache control pipeline 132 performs abort processing of the inserted request. The abort processing represents an example of “termination processing”. Herein, the explanation is given for a case in which the pipeline processing is performed by the cache control pipeline 132 in the stages 0 to n. The cache control pipeline 132 represents an example of a “control pipeline”.

The tag RAM 133 implements the functions of the tag storing unit 101 illustrated in FIG. 1. The data RAM 134 implements the functions of the data storing unit 102 illustrated in FIG. 1. The tag RAM 133 is used to store the tag data related to the cache line of the data RAM 134.

The order lock circuit 135 implements the functions of the local order control unit 107 illustrated in FIG. 1. The order lock circuit 135 is a lock resource for recording the order-processing-issued addresses. When there is a match with the address held by a new request, the order lock circuit 135 aborts orders with respect to that address until the concerned order processing is completed.

The MIB circuit 136 implements the functions of the erroneous access control unit 108 illustrated in FIG. 1. The MIB circuit 136 holds cache miss addresses. Then, when the address specified in a request matches with a held address, it implies that a preceding request has already been issued for obtaining, from the memory 40, the same data as the data requested in the concerned request. Hence, the MIB circuit 136 aborts the concerned request.

The storage lock circuit 137 is a lock resource for recording the address specified in each storage request issued with respect to the MAC 30. Until a notification about finalization of the storage sequence is received from the MAC 30, the storage lock circuit 137 aborts subsequent storage requests having the same address.

The takeout directory circuit 138 implements the functions of the directory table storing unit 103 illustrated in FIG. 1. The takeout directory circuit 138 is used in cache coherency control among the clusters.

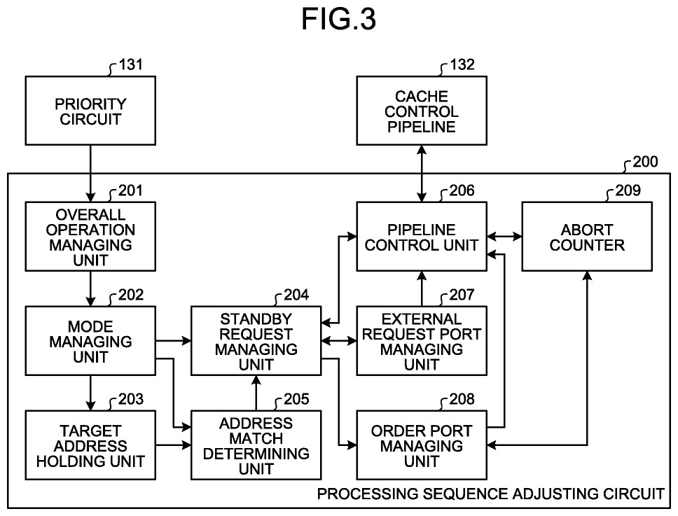

The processing sequence adjusting circuit 200 implements the functions of the processing sequence adjusting unit 106. FIG. 3 is a block diagram of the processing sequence adjusting circuit. As illustrated in FIG. 3, the processing sequence adjusting circuit 200 includes an overall operation managing unit 201, a mode managing unit 202, a target address holding unit 203, a standby request managing unit 204, and an address match determining unit 205. Moreover, the processing sequence adjusting circuit 200 includes a pipeline control unit 206, an external request port managing unit 207, an order port managing unit 208, and an abort counter 209.

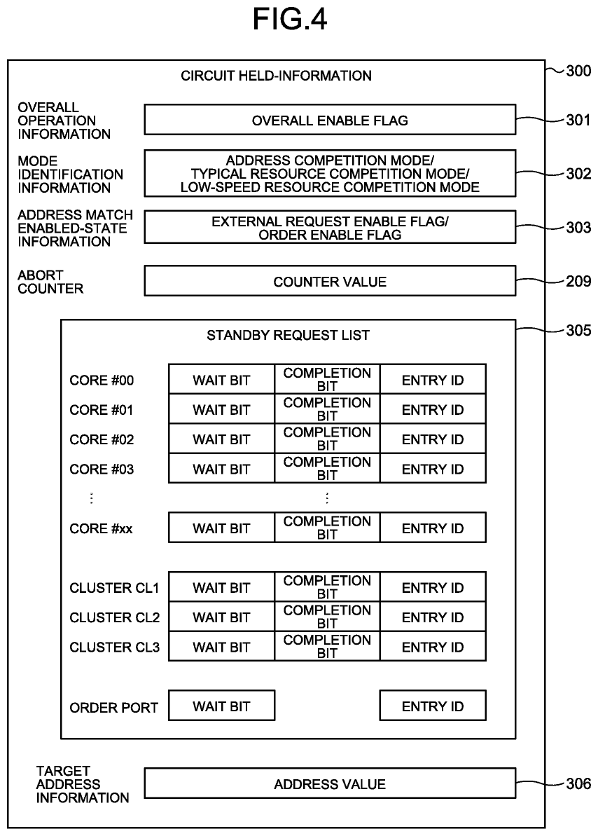

FIG. 4 is a diagram in which the held information in the processing sequence adjusting circuit is compiled. The processing sequence adjusting circuit 200 has a circuit held-information 300 which includes overall operation information 301, mode identification information 302, address match enabled-state information 303, the abort counter 209, a standby request list 305, and target address information 306.

The overall operation information 301 indicates an overall enable flag about whether or not the processing sequence adjusting circuit 200 is monitoring the processing sequence of the requests. When the overall enable flag is on, it implies that the processing sequence adjusting circuit 200 is monitoring the processing sequence of the requests. On the other hand, when the overall enable flag is off, it implies that the processing sequence adjusting circuit 200 is not monitoring the processing sequence of the requests. The overall operation information 301 is held by, for example, the overall operation managing unit 201.

The mode identification information 302 indicates the monitoring mode, from among three monitoring modes, namely, an address competition mode, a typical resource competition mode, and a low-speed resource competition mode, in which the processing sequence adjusting circuit 200 is operating. The address competition mode is the mode for monitoring the competition among local requests, external requests, and orders. The typical resource competition mode is the mode for monitoring the competition among typical NC requests. The low-speed resource competition mode is the mode for monitoring the competition among low-speed NC requests. The mode identification information 302 is held by, for example, the mode managing unit 202.

The address match enabled-state information 303 is information that, when the LLC 100 is the home LLC for the data specified in the request, indicates an external request enable flag about whether or not the monitoring of the external requests is enabled. When the external request enable flag is on, then the monitoring of the external requests is enabled. When the LLC 100 is the home LLC for the data specified in a request, the address match enabled-state information 303 is held by the external request port managing unit 207.

On the other hand, the address match enabled-state information 303 is information that, when the LLC 100 is not the home LLC for the data specified in the request, indicates an order enable flag about whether or not the monitoring of the orders is enabled. When the order enable flag is on, then the monitoring of the orders is enabled. When the LLC 100 is not the home LLC for the data specified in the request, the address match enabled-state information 303 is held by the order port managing unit 208.

The abort counter 209 holds a counter value indicating the number of times for which the orders are aborted.

In the standby request list 305; a wait bit, a completion bit, and an entry identifier (ID) are registered for each core 20. The wait bit indicates whether or not a local request representing a standby request is present. The completion bit indicates whether or not the processing of the local request, which is a standby request, is completed. The entry ID indicates an entry number of the resource of the local request port 110 corresponding to the core 20. For example, when the local request port 110 includes four entries, the entry ID is 2-bit information. In FIG. 4, the cores 20 of the cluster 10 are referred to as a core #00 to a core #xx. When the wait bit is “1”, it indicates that the requests issued from the entry ID of the core 20 have become standby requests. On the other hand, when the wait bit is “0”, it indicates that the requests output from the concerned core 20 do not include any standby request.

In the standby request list 305; wait bits, the completion bits, and the entry IDs are registered in a corresponding manner to the clusters 11 to 13. For example, when the external request port 121 includes eight entries, the entry ID is 3-bit information. Moreover, in the standby request list 305, the wait bits and the entry IDs are registered in a corresponding manner to the order port 122. The standby request list 305 is held by, for example, the standby request managing unit 204.

The target address information 306 is the target address value to be monitored in the case of monitoring competition among the local requests, the external requests, and the orders. The target address information 306 is held by, for example, the target address holding unit 203.

Explained below with reference to FIGS. 3 and 4 are the details of the processing sequence adjusting circuit 200. The processing sequence adjusting circuit 200 represents an example of a “sequence adjusting unit”.

The overall operation managing unit 201 obtains, from the priority circuit 131, the information about a request inserted in the cache control pipeline 132 in the stage 0 of the pipeline processing. The information about the request contains the type of the request, the address of the request, and the source information. Then, the overall operation managing unit 201 checks the overall enable flag represented by the overall operation information 301, and determines whether or not the processing sequence of the requests is being monitored.

When the monitoring is not being performed, then the overall operation managing unit 201 sends the information about the request to the mode managing unit 202 and the standby request managing unit 204 and issues an instruction for initial registration. Subsequently, when the inserted request becomes the target for monitoring, the overall operation managing unit 201 receives a notification about the start of monitoring from the mode managing unit 202. Then, the overall operation managing unit 201 changes the overall enable flag, which is represented by the overall operation information 301, to indicate that the monitoring is being performed, and starts the monitoring operation. However, when the inserted request is not treated as the target for monitoring, then the overall operation managing unit 201 ends the operations without performing the monitoring operation.

On the other hand, when the monitoring is being performed, then the overall operation managing unit 201 sends the information about the request to the mode managing unit 202 and the standby request managing unit 204 and instructs subsequent-request processing. Herein, the subsequent request implies the request that is issued at a later point of time and that competes against the request already inserted in the pipeline.

Then, the overall operation managing unit 201 receives a notification about the end of monitoring from the standby request managing unit 204. Subsequently, the overall operation managing unit 201 changes the overall enable flag in the overall operation information 301 to the state indicating that monitoring operation is not enabled, and ends the monitoring operation.

The mode managing unit 202 receives an instruction for initial registration from the overall operation managing unit 201. Moreover, the mode managing unit 202 obtains the information about the request from the overall operation managing unit 201. Then, the mode managing unit 202 determines the request type from the information about the request.

Subsequently, the mode managing unit 202 determines, from the request type, whether the monitoring mode for the obtained request is the address competition mode, or the typical resource competition mode, or the low-speed resource competition mode. More particularly, when the request type indicates a local request, the mode managing unit 202 determines to perform monitoring in the address competition mode. Alternatively, when the request type indicates a typical NC request, the mode managing unit 202 determines to perform monitoring in the typical resource competition mode. Still alternatively, when the request type indicates a low-speed NC request, the mode managing unit 202 determines to perform monitoring in the low-speed resource competition mode.

When the operations are to be performed in the address competition mode, the mode managing unit 202 sets the mode identification information 302 to the address competition mode. Then, the mode managing unit 202 notifies the overall operation managing unit 201 about the start of monitoring in the address competition mode. Subsequently, the mode managing unit 202 issues an instruction for starting monitoring in the address competition mode to the standby request managing unit 204. Moreover, the mode managing unit 202 notifies the target address holding unit 203 about the address specified in the information about the request.

When the operations are to be performed in the typical resource competition mode, the mode managing unit 202 sets the mode identification information 302 to the typical resource competition mode. Then, the mode managing unit 202 notifies the overall operation managing unit 201 about the start of monitoring in the typical resource competition mode. Subsequently, the mode managing unit 202 issues an instruction for starting monitoring in the typical resource competition mode to the standby request managing unit 204.

When the operations are to be performed in the low-speed resource competition mode, the mode managing unit 202 sets the mode identification information 302 to the low-speed resource competition mode. Then, the mode managing unit 202 notifies the overall operation managing unit 201 about the start of monitoring in the low-speed resource competition mode. Moreover, the mode managing unit 202 issues an instruction for starting monitoring in the low-speed resource competition mode to the standby request managing unit 204.

Meanwhile, when the inserted request is not to be treated as the target for monitoring, the mode managing unit 202 determines not to perform the monitoring. A case in which a request does not belong to any of the three monitoring modes, namely, the address competition mode, the typical resource competition mode, and the low-speed resource competition mode is, for example, the case in which the request indicates a system register access. Then, the mode managing unit 202 instructs the overall operation managing unit 201 to stop the monitoring operation, and ends the registration operation.

When the monitoring is being performed, the mode managing unit 202 receives, from the overall operation managing unit 201, an instruction for processing the subsequent request. Moreover, the mode managing unit 202 obtains, from the overall operation managing unit 201, the information about the request inserted into the cache control pipeline 132. Then, the mode managing unit 202 determines the request type from the information about the request. Moreover, the mode managing unit 202 checks the mode identification information 302 and determines the current monitoring mode.

Then, the mode managing unit 202 determines whether or not the inserted request represents the target for monitoring in the implemented monitoring mode. When the inserted request does not represent the target for monitoring in the implemented monitoring mode, then the mode managing unit 202 makes the standby request managing unit 204 and the pipeline control unit 206 insert the request in the cache control pipeline 132 without sending an abort instruction.

When the monitoring mode is set to the address competition mode and when the request is the target for monitoring, the mode managing unit 202 outputs the information about the request and an address confirmation request to the address match determining unit 205. When the monitoring mode is set to the typical resource competition mode and when the request is the target for monitoring, the mode managing unit 202 outputs a standby-request determination request regarding the typical NC request to the standby request managing unit 204. When the monitoring mode is set to the low-speed resource competition mode and when the request is the target for monitoring, the mode managing unit 202 outputs a standby-request determination request regarding the low-speed NC request to the standby request managing unit 204.

The target address holding unit 203 is used to store and hold the address that is targeted in the cacheable request notified by the mode managing unit 202.

When the monitoring mode is set to the address competition mode and when the request is the target for monitoring, the address match determining unit 205 receives input of the information about the request and an address confirmation request from the mode managing unit 202. Then, the address match determining unit 205 obtains, from the information about the request, the address specified in the request. Subsequently, the address match determining unit 205 obtains the target address for monitoring from the target address information 306, and determines whether the target address for monitoring matches with the address specified in the request. When the addresses do not match, then the address match determining unit 205 notifies the standby request managing unit 204 about the mismatch of addresses. When the addresses are matching, the address match determining unit 205 outputs the information about the request and a standby-request determination request to the standby request managing unit 204.

In the initial registration operation, the standby request managing unit 204 receives the information about the monitoring mode and an instruction for starting monitoring from the mode managing unit 202. Moreover, the standby request managing unit 204 receives input of the information about the request from the overall operation managing unit 201.

When the inserted request is a cacheable request, then the standby request managing unit 204 receives an instruction for starting monitoring in the address competition mode from the mode managing unit 202. Then, the standby request managing unit 204 obtains the source core 20 and the entry ID from the information about the request as obtained from the overall operation managing unit 201. Then, in the field corresponding to the obtained core 20 in the standby request list 305, the standby request managing unit 204 sets the wait bit to “1”, and adds standby request information by registering a value indicating the entry ID.

Then, the standby request managing unit 204 determines whether or not the cluster 10 is the home cluster for the data requested by the request. When the cluster 10 is not the home cluster, then the standby request managing unit 204 instructs the order port managing unit 208 to set the order enable flag in the address match enabled-state information 303. On the other hand, When the cluster 10 is the home cluster, the standby request managing unit 204 instructs the external request port managing unit 207 to set the external request enable flag and sends the information about the request to the external request port managing unit 207.

When the request is a typical NC request, then the standby request managing unit 204 receives an instruction for starting monitoring in the typical resource competition mode from the mode managing unit 202. Then, the standby request managing unit 204 obtains, from the information about the request as obtained from the overall operation managing unit 201, the information about the source core 20 and the entry ID. Subsequently, in the field corresponding to the obtained core 20 in the standby request list 305, the standby request managing unit 204 sets the wait bit to “1”, and adds standby request information by registering a value indicating the entry ID.

When the request is a low-speed NC request, then the standby request managing unit 204 receives an instruction for starting monitoring in the low-speed resource competition mode from the mode managing unit 202. Then, the standby request managing unit 204 obtains, from the information about the request as obtained from the overall operation managing unit 201, the information about the source core 20 and the entry ID. Subsequently, in the field corresponding to the obtained core 20 in the standby request list 305, the standby request managing unit 204 sets the wait bit to “1”, and adds standby request information by registering a value indicating the entry ID.

In the case of subsequent-request processing, the standby request managing unit 204 performs the following operations. When the monitoring mode is set to the address competition mode, when the request is the target for monitoring, and when the address specified in the request matches with the target address information 306; the standby request managing unit 204 receives a standby-request determination request from the address match determining unit 205. Moreover, the standby request managing unit 204 receives input of the information about the request from the address match determining unit 205. Then, the standby request managing unit 204 refers to the information about the request and determines whether the request is a local request, or an external request, or an order.

When the request is a local request, then the standby request managing unit 204 refers to the address match enabled-state information 303 and determines whether or not the external request monitoring is enabled. When the external request monitoring is not enabled, then the standby request managing unit 204 instructs the external request port managing unit 207 to determine whether or not to start monitoring of external requests.

Subsequently, the standby request managing unit 204 obtains the information about the source core 20 from the information about the request. Then, the standby request managing unit 204 checks the value of the completion bit in the field of the source core 20 in the standby request list 305. Subsequently, the standby request managing unit 204 determines whether or not the processing requested by the local request with respect to the same address as the address output from the source code 20 has been completed. In the following explanation, the fact that the processing requested by a request has been completed is called “completion of requested processing”. The request for which the requested processing has been completed represents an example of a “completed request”.

When the requested processing has been completed, then the standby request managing unit 204 instructs the pipeline control unit 206 to mandatorily abort the inserted local request. On the other hand, When the requested processing is not yet completed, then the standby request managing unit 204 checks the wait bit in the field of the source core 20 in the standby request list 305 and determines whether or not it is possible to hold a standby request.

When the wait bit is set to “1” and when it is difficult to hold a standby request on account of the existing standby requests, then the standby request managing unit 204 instructs the pipeline control unit 206 to mandatorily abort the inserted local request. On the other hand, when the wait bit is set to “0” and when there are no standby requests, then the standby request managing unit 204 sets the wait bit to “1” in the field of the source core 20 in the standby request list 305 and additionally registers a standby request. In that case, the standby request managing unit 204 does not issue a mandatory abort instruction.

When the request is an external request, then the standby request managing unit 204 checks the address match enabled-state information 303 and determines whether or not monitoring of external requests is enabled. When monitoring of external requests is enabled, then the standby request managing unit 204 obtains the information about the source cluster, from among the clusters 11 to 13, from the information about the request. In the following explanation, one of the clusters 11 to 13 represents the source cluster. Then, the standby request managing unit 204 checks the value of the completion bit in the field of the source cluster in the standby request list 305. Subsequently, the standby request managing unit 204 determines whether or not the processing requested by the external request with respect to the same address as the address output from the source cluster has been completed.

When the requested processing has been completed, then the standby request managing unit 204 instructs the pipeline control unit 206 to mandatorily abort the inserted external request. On the other hand, when the requested processing is not yet completed, then the standby request managing unit 204 checks the wait bit in the field of the source cluster in the standby request list 305 and determines whether or not it is possible to hold a standby request.

When the wait bit is set to “1” and When it is difficult to hold a standby request on account of the existing standby requests, then the standby request managing unit 204 instructs the pipeline control unit 206 to mandatorily abort the inserted external request. On the other hand, when the wait bit is set to “0” and when there are no standby requests, then the standby request managing unit 204 sets the wait bit to “1” in the field of the source cluster in the standby request list 305 and additionally registers a standby request. In that case, the standby request managing unit 204 does not issue a mandatory abort instruction.

Meanwhile, when monitoring of external requests is not enabled, then the standby request managing unit 204 instructs the external request port managing unit 207 to determine the start of monitoring of external requests.

When the request is an order, then the standby request managing unit 204 instructs the order port managing unit 208 to set the order enable flag. Then, the standby request managing unit 204 receives input of an order determination request from the order port managing unit 208. Subsequently, the standby request managing unit 204 checks the wait bit in the field of the source order port in the standby request list 305, and determines whether or not it is possible to hold a standby request.

When the wait bit is set to “0” and when there are no standby requests, then the standby request managing unit 204 sets the wait bit to “1” in the field of the source order port in the standby request list 305 and additionally registers a standby request. In that case, the standby request managing unit 204 does not issue a mandatory abort instruction.

Meanwhile, when the monitoring mode is set to the typical resource competition mode and when the request is the target for monitoring, the standby request managing unit 204 receives a standby-request determination request regarding the typical NC request from the mode managing unit 202. Then, the standby request managing unit 204 obtains the information about the source core 20 from the information about the request. Subsequently, the standby request managing unit 204 checks the value of the completion bit in the field of the source core 20 in the standby request list 305. Then, the standby request managing unit 204 determines whether or not the processing requested by the typical NC request, which is output from the concerned core 20, has already been completed.

When the requested processing has already been completed, then the standby request managing unit 204 instructs the pipeline control unit 206 to mandatorily abort the inserted typical NC request. On the other hand, when the requested processing is not yet completed, then the standby request managing unit 204 checks the wait bit in the field of the source core 20 in the standby request list 305, and determines whether or not it is possible to hold a standby request.

When the wait bit is set to “1” and when it is difficult to hold a standby request on account of existing standby requests, then the standby request managing unit 204 instructs the pipeline control unit 206 to mandatorily abort the typical NC request. On the other hand, when the wait bit is set to “0” and when there are no standby requests, then the standby request managing unit 204 sets the wait bit to “1” in the field of the source core 20 in the standby request list 305, and additionally registers a standby request. In that request, the standby request managing unit 204 does not issue a mandatory abort instruction.

When the monitoring mode is set to the low-speed resource competition mode and when the request is the target for monitoring, then the standby request managing unit 204 receives a standby-request determination request regarding the low-speed NC request from the mode managing unit 202. Then, the standby request managing unit 204 obtains the information about the source core 20 from the information about the request. Subsequently, the standby request managing unit 204 checks the value of the completion bit in the field of the source core 20 in the standby request list 305. Then, the standby request managing unit 204 determines whether or not the processing request by the low-speed NC request, which is output by the core 20, has been completed.

When the processing of the request has been completed, then the standby request managing unit 204 instructs the pipeline control unit 206 to mandatorily abort the inserted low-speed NC request. On the other hand, when the processing of the request is not yet completed, then the standby request managing unit 204 checks the wait bit in the field of the source core 20 in the standby request list 305 and determines whether or not it is possible to hold a standby request.

When the wait bit is set to “1” and when it is difficult to hold a standby request on account of existing standby requests, then the standby request managing unit 204 instructs the pipeline control unit 206 to mandatorily abort the inserted low-speed NC request. On the other hand, when the wait bit is set to “0” and when there are no standby requests, then the standby request managing unit 204 sets the wait bit to “1” in the field of the source core 20 in the standby request list 305 and additionally registers a standby request. In that case, the standby request managing unit 204 does not issue a mandatory abort instruction.

Meanwhile, when the request is not the target for monitoring in the implemented operation mode, then the standby request managing unit 204 ends the determination operation. In that case, the standby request managing unit 204 does not issue a mandatory abort instruction.

When the pipeline processing performed by the cache control pipeline 132 with respect to the inserted request is completed, the standby request managing unit 204 receives input of a processing response from the pipeline control unit 206. Herein, with respect to a request inserted in the cache control pipeline, the pipeline processing implies either the requested processing or the abort processing.

Then, the standby request managing unit 204 obtains, from the processing response, the information about the source of the request and the entry ID. Subsequently, the standby request managing unit 204 determines whether or not the standby request list 305 includes information matching with the information about the source and the entry ID, that is, determines whether or not the request for which the pipeline processing is completed is a standby request. When the request is not a standby request, then the standby request managing unit 204 ends the operations performed at the time of completion of the pipeline processing.

On the other hand, when the request is a standby request, then the standby request managing unit 204 determines whether or not the processing request is an abort notification. When the processing response is a notification of completion of the requested processing, the standby request managing unit 204 determines whether or not the request for which the requested processing is completed is an order. When the request is not an order, then the standby request managing unit 204 sets the completion bit to “1” in the field corresponding to the request in the standby request list 305 for which the requested processing is completed, and adds a completion flag. On the other hand, when the request is an order, then the standby request managing unit 204 sets the wait bit to “0” in the order port in the standby request list 305, and eliminates the standby request.

Subsequently, the standby request managing unit 204 determines whether or not all standby requests representing local requests registered in the standby request list 305 are completed. When all standby requests representing local requests registered in the standby request list 305 are completed, then the standby request managing unit 204 determines whether or not the cluster 10 is the home cluster for the data requested by the target request for monitoring.

When the cluster 10 is the home cluster for the data requested by the target request for monitoring, then the standby request managing unit 204 instructs the external request port managing unit 207 to reset the address match enabled-state information 303. On the other hand, when the cluster 10 is not the home cluster for the data requested by the target request for monitoring, then the standby request managing unit 204 instructs the order port managing unit 208 to reset the address match enabled-state information 303. Meanwhile, when there is any unprocessed standby request representing a local request, then the standby request managing unit 204 maintains the same state of the address match enabled-state information 303.

Subsequently, the standby request managing unit 204 determines whether or not the processing requested by all standby requests registered in the standby request list 305 is completed. When the processing requested by all standby requests is completed, then the standby request managing unit 204 notifies the overall operation managing unit 201 about the end of monitoring. On the other hand, when there is any standby request for which the requested processing is not completed, the standby request managing unit 204 continues with the monitoring of the requests.

Meanwhile, when the processing response indicates abort processing, the standby request managing unit 204 determines whether or not the request for which the pipeline processing is completed is an order. When the request is not an order, then the standby request managing unit 204 continues with the monitoring of the requests.

On the other hand, when the request is an order, then the standby request managing unit 204 notifies the order port managing unit 208 about aborting of the order. Subsequently, the standby request managing unit 204 continues with the monitoring of the requests.

The cluster 10 that is likely to receive an order is the home cluster for the inserted request. When the request is a cacheable request, then the order port managing unit 208 receives an instruction for setting the order enable flag from the standby request managing unit 204 at the time of initial registration. Subsequently, the order port managing unit 208 sets the order enable flag to “1” in the address match enabled-state information 303. As a result, the monitoring of orders is enabled. Moreover, the order port managing unit 208 initializes the abort counter 209 and sets the counter value to “O”.

In the subsequent-request processing, when the inserted request is an order, then the order port managing unit 208 receives an instruction for setting the order enable flag from the standby request managing unit 204. Subsequently, the order port managing unit 208 refers to the address match enabled-state information 303 and determines whether or not the monitoring of orders is enabled. When the monitoring of orders is enabled, then the order port managing unit 208 outputs an order determination request to the standby request managing unit 204.

On the other hand, when the monitoring of orders is not enabled; then, at the time of storing, in the cache, the data received in response from the home cluster 10, the order port managing unit 208 sets the order enable flag to “1” in the address match enabled-state information 303. As a result, the monitoring of orders is enabled. The order port managing unit 208 initializes the abort counter 209 and sets the counter value to “0”. At that time, the order port managing unit 208 outputs an order determination request to the standby request managing unit 204.

When the processing requested by the request is completed and when the cluster 10 is not the home cluster for the data requested by the target request for monitoring, then the order port managing unit 208 receives an instruction for resetting the address match enabled-state information 303 from the standby request managing unit 204. Then, the order port managing unit 208 sets the order enable flag to “0” in the address match enabled-state information 303. As a result, the monitoring of orders is no more enabled.

When abort processing of the order is performed in the pipeline processing, then the order port managing unit 208 receives a notification about aborting of the order from the standby request managing unit 204. Then, the order port managing unit 208 increments the counter value of the abort counter 209 by one.

Subsequently, the order port managing unit 208 determines whether or not the counter value of the abort counter 209 is equal to or greater than a threshold value. When the counter value of the abort counter 209 is equal to or greater than the threshold value, then the order port managing unit 208 sets the order enable flag to “0” in the address match enabled-state information 303 so that the monitoring of orders is not enabled. The threshold value for the counter value of the abort counter 209 can be set to a value that enables detection of the fact that there is no progress in the processing on account of termination of the processing requested by the order. For example, when it is thought that aborting the order for nine times is highly likely to cause stagnation in the processing of cacheable requests in the CPU 1, then the threshold value can be set to “9”.

When the request is a cacheable request and when the cluster 10 is the home cluster for the inserted request, then the external request port managing unit 207 receives an instruction for setting the external request enable flag from the standby request managing unit 204 at the time of initial registration. Moreover, the external request port managing unit 207 obtains the information about the request from the standby request managing unit 204. Then, the external request port managing unit 207 refers to the request information and determines whether or not the request is a local request having exclusivity.

When the request has exclusivity, then the external request port managing unit 207 sets the external request enable flag to “1” in the address match enabled-state information 303. As a result, the monitoring of external requests is enabled. On the other hand, when the request does not have exclusivity, then the external request port managing unit 207 sets the external request enable flag to “0” in the address match enabled-state information 303. As a result, the monitoring of external requests is not enabled.

In the subsequent-request processing, when the inserted request is a local request and when the monitoring of external requests is not enabled, then the external request port managing unit 207 receives an instruction for determining the start of monitoring of external requests from the standby request managing unit 204. Then, the external request port managing unit 207 determines the start of monitoring of external requests as explained below.

The external request port managing unit 207 determines whether or not the inserted request is a local request having exclusivity. When the inserted request is a local request having exclusivity, then the external request port managing unit 207 sets the external request enable flag to “1” in the address match enabled-state information 303. As a result, the monitoring of external requests is enabled.

On the other hand, when the request is not a local request having exclusivity, then the external request port managing unit 207 maintains “0” in the external request enable flag representing the address match enabled-state information 303. In that case, the monitoring of external requests remains disabled.

Moreover, in the subsequent-request processing, when the inserted request is an external request and when the monitoring of external requests is not enabled, then the external request port managing unit 207 receives an instruction for determining the start of monitoring of external requests from the standby request managing unit 204. Then, the external request port managing unit 207 determines the start of monitoring of external requests.

When the pipeline processing is completed, when the cluster 10 is the home cluster for the data requested by the target request for monitoring, then the external request port managing unit 207 receives an instruction for resetting the address match enabled-state information 303 from the standby request managing unit 204. Subsequently, the external request port managing unit 207 sets the external request enable flag to “0” in the address match enabled-state information 303. As a result, the monitoring of external requests is not enabled.

In the initial registration operation, the pipeline control unit 206 does not instruct the cache control pipeline 132 to perform mandatory abort processing, and continues with the normal pipeline processing with respect to the request inserted in the cache control pipeline 132.

In the subsequent-request processing, the pipeline control unit 206 receives an instruction for mandatorily aborting the inserted request from the standby request managing unit 204. Then the pipeline control unit 206 instructs the cache control pipeline 132 to perform mandatory abort processing. In response, the cache control pipeline 132 aborts the inserted request.

The pipeline control unit 206 receives, from the cache control pipeline 132, a processing response indicating either a requested-processing completion notification or a requested-processing abort notification according to the processing result at the timing of the stage n of the pipeline processing, that is, at the completion of the pipeline processing. The processing response includes the information about the source of the request and the entry ID. Then, the pipeline control unit 206 outputs the received processing response to the standby request managing unit 204.

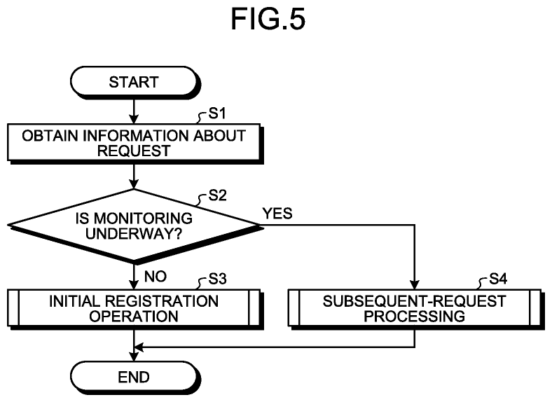

Explained below with reference to FIG. 5 is a processing-start operation performed by the CPU 1 at the time of insertion of a request. FIG. 5 is a flowchart for explaining the processing-start operation performed at the time of insertion of a request.

The overall operation managing unit 201 obtains, from the priority circuit 131, the information about a request inserted in the cache control pipeline 132 (Step S1). The information about the request contains an address.

Then, the overall operation managing unit 201 checks the overall enable flag represented by the overall operation information 301 and determines whether or not the monitoring of the processing sequence of requests is being performed (Step S2).

When the monitoring is not being performed (No at Step S2), then the overall operation managing unit 201 sends the information about the request to the mode managing unit 202 and the standby request managing unit 204, and instructs initial registration. In response, the processing sequence adjusting circuit 200 performs initial registration (Step S3).

On the other hand, when the monitoring is being performed (Yes at Step S2), then the overall operation managing unit 201 sends the information about the request to the mode managing unit 202 and the standby request managing unit 204, and instructs subsequent-request processing. In response, the processing sequence adjusting circuit 200 performs subsequent-request processing (Step S4).

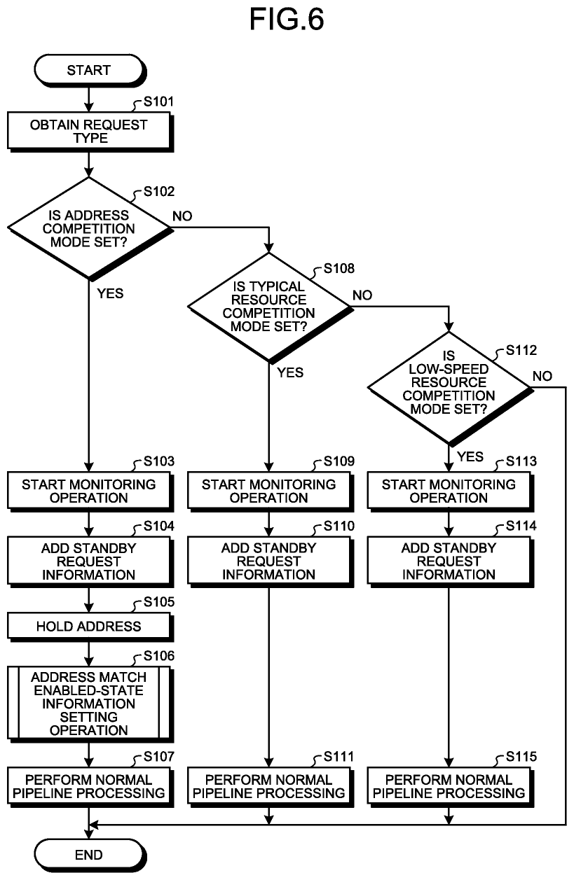

Explained below with reference to FIG. 6 is a flow of the initial registration operation. FIG. 6 is a flowchart for explaining the initial registration operation. The flow illustrated in FIG. 6 represents an example of the operations performed at Step S3 illustrated in FIG. 5.

The mode managing unit 202 obtains the information about the request from the overall operation managing unit 201. Then, the mode managing unit 202 obtains the request type from the information about the request (Step S101).

Then, the mode managing unit 202 determines, from the obtained request type, whether or not to perform operations in the address competition mode (Step S102). More particularly, the mode managing unit 202 determines to perform monitoring in the address competition mode when the request type indicates a local request.

In the case of performing operations in the address competition mode (Yes at Step S102), the mode managing unit 202 sets the mode identification information 302 to the address competition mode. Then, the mode managing unit 202 notifies the overall operation managing unit 201 about the start of monitoring in the address competition mode. The overall operation managing unit 201 changes the overall enable flag, which is represented by the overall operation information 301, to indicate that the monitoring is underway, and starts the monitoring operation (Step S103).

Subsequently, the mode managing unit 202 instructs the standby request managing unit 204 to start monitoring in the address competition mode. The standby request managing unit 204 receives the instruction for starting monitoring in the address competition mode from the mode managing unit 202, and obtains the source core 20 and the entry ID from the information about the request as obtained from the overall operation managing unit 201. Then, the standby request managing unit 204 sets the wait bit to “1” in the field corresponding to the obtained core 20 in the standby request list 305, and adds standby request information by registering the value representing the entry ID (Step S104).

Moreover, the mode managing unit 202 notifies the target address holding unit 203 about the address specified in the information about the request. Then, the target address holding unit 203 stores and holds the address notified by the mode managing unit 202 (Step S105).

Moreover, the standby request managing unit 204, the external request port managing unit 207, and the order port managing unit 208 perform an address match enabled-state information setting operation (Step S106). Regarding the address match enabled-state information setting operation, the detailed explanation is given later.

In that case, the standby request managing unit 204 does not send a notification for mandatory abort processing to the pipeline control unit 206. Hence, the pipeline control unit 206 does not instruct the cache control pipeline 132 to perform mandatory abort processing. Thus, the cache control pipeline 132 continues with the normal pipeline processing with respect to the inserted request (Step S107).

Meanwhile, in the case of not performing operations in the address competition mode (No at Step S102), the mode managing unit 202 determines whether or not to perform operations in the typical resource competition mode (Step S108). More particularly, the mode managing unit 202 determines to perform monitoring in the normal resource competition mode when the request type indicates a typical NC request.

In the case of performing operations in the typical resource competition mode (Yes at Step S108), the mode managing unit 202 sets the mode identification information 302 to the typical resource competition mode. Then, the mode managing unit 202 notifies the overall operation managing unit 201 about the start of monitoring in the typical resource competition mode. The overall operation managing unit 201 changes the overall enable flag, which is represented by the overall operation information 301, to indicate that the monitoring is underway, and starts the monitoring operation (Step S109).

Subsequently, the mode managing unit 202 instructs the standby request managing unit 204 to start monitoring in the typical resource competition mode. The standby request managing unit 204 receives the instruction to start monitoring in the typical resource competition mode from the mode managing unit 202, and obtains the source core 20 and the entry ID from the information about the request as obtained from the overall operation managing unit 201. Then, the standby request managing unit 204 sets the wait bit to “1” in the field corresponding to the obtained core 20 in the standby request list 305, and adds standby request information by registering the value representing the entry ID (Step S110).

In this case too, the standby request managing unit 204 does not notify the pipeline control unit 206 about mandatory abort processing. Hence, the pipeline control unit 206 does not instruct the cache control pipeline 132 to perform mandatory abort processing with respect to the cache control pipeline 132. Thus, the cache control pipeline 132 continues with the normal pipeline processing with respect to the inserted request (Step S111).

On the other hand, in the case of not performing operations in the typical resource competition mode (No at Step S108), the mode managing unit 202 determines whether or not to perform operations in the low-speed resource competition mode (Step S112). More particularly, the mode managing unit 202 determines to perform monitoring in the low-speed resource competition mode when the request type indicates a low-speed NC request.

In the case of performing operations in the low-speed competition mode (Yes at Step S112), the mode managing unit 202 sets the mode identification information 302 to the low-speed resource competition mode. Then, the mode managing unit 202 notifies the overall operation managing unit 201 about the start of monitoring in the low-speed resource competition mode. The overall operation managing unit 201 changes the overall enable flag, which is represented by the overall operation information 301, to indicate that the monitoring is underway, and starts the monitoring operation (Step S113).

Subsequently, the mode managing unit 202 instructs the standby request managing unit 204 to start monitoring in the low-speed resource competition mode. The standby request managing unit 204 receives the instruction to start monitoring in the low-speed resource competition mode from the mode managing unit 202, and obtains the source core 20 and the entry ID from the information about the request as obtained from the overall operation managing unit 201. Then, the standby request managing unit 204 sets the wait bit to “1” in the field corresponding to the obtained core 20 in the standby request list 305, and adds standby request information by registering the value representing the entry ID (Step S114).

In that case too, the standby request managing unit 204 does not send a notification for mandatory abort processing to the pipeline control unit 206. Hence, the pipeline control unit 206 does not instruct the cache control pipeline 132 to perform mandatory abort processing. Thus, the cache control pipeline continues with the normal pipeline processing with respect to the inserted request (Step S115).

On the other hand, in the case of not performing operations in the low-speed resource competition mode (No at Step S112), the mode managing unit 202 determines not to perform monitoring. Then, the mode managing unit 202 instructs the overall operation managing unit 201 to terminate the monitoring operation, and ends the registration operation.

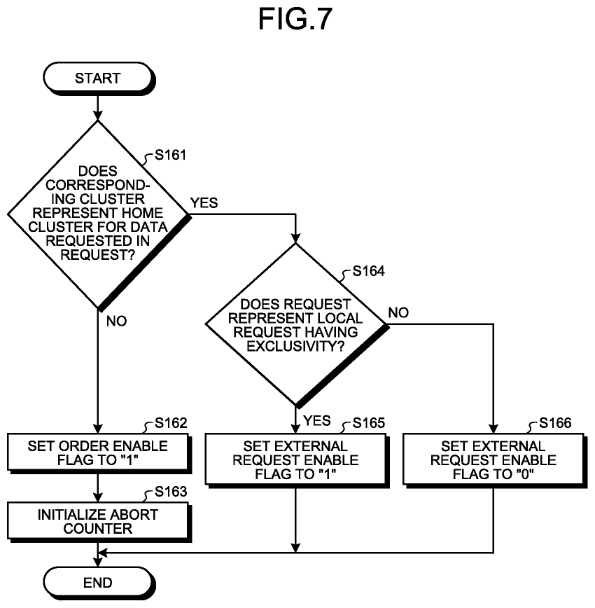

Explained below with reference to FIG. 7 is a flow of the address match enabled-state information setting operation. FIG. 7 is a flowchart for explaining the address match enabled-state information setting operation. The flow illustrated in FIG. 7 represents an example of the operations performed at Step S106 illustrated in FIG. 6.

The standby request managing unit 204 determines whether or not the corresponding cluster is the home cluster for the data requested by the request (Step S161).

When the corresponding cluster is not the home cluster (No at Step S161), then the standby request managing unit 204 instructs the order port managing unit 208 to set the order enable flag. In response to the instruction for setting the order enable flag as received from the standby request managing unit 204, the order port managing unit 208 sets the order enable flag to “1” (Step S162). As a result, the monitoring of orders is enabled.

Then, the order port managing unit 208 initializes the abort counter 209, and sets the counter value to “0” (Step S163).

Meanwhile, when the corresponding cluster is the home cluster (Yes at Step S161), then the standby request managing unit 204 instructs the external request port managing unit 207 to set the external request enable flag and sends the information about the request to the external request port managing unit 207. The external request port managing unit 207 refers to the information about the request as received from the standby request managing unit 204, and determines whether or not the request is a local request having exclusivity (Step S164).

When the request has exclusivity (Yes at Step S164), then the external request port managing unit 207 sets the external request enable flag to “1” in the address match enabled-state information 303 (Step S165). As a result, the monitoring of external requests is enabled.

On the other hand, when the request does not have exclusivity (No at Step S164), then the external request port managing unit 207 sets the external request enable flag to “O” in the address match enabled-state information 303 (Step S166). As a result, the monitoring of external requests is disabled.

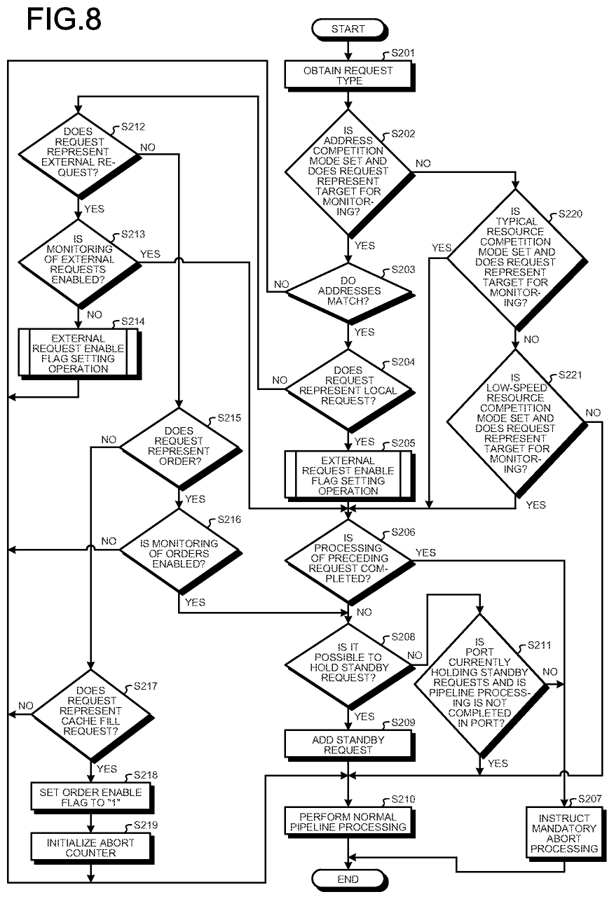

Explained below with reference to FIG. 8 is a flow of the subsequent-request processing performed after the monitoring of requests has already started. FIG. 8 is a flowchart for explaining the subsequent-request processing. The flow illustrated in FIG. 8 is an example of the operations performed at Step S4 illustrated in FIG. 5.

The mode managing unit 202 obtains the information about the request, which is inserted into the cache control pipeline 132, from the overall operation managing unit 201. Then, the mode managing unit 202 obtains the request type from the information about the request (Step S201). Moreover, the mode managing unit 202 checks the mode identification information 302 and identifies the current monitoring mode.

Subsequently, the mode managing unit 202 determines whether or not the address competition mode is the current monitoring mode and whether or not the obtained request is the target for monitoring in the address competition mode (Step S202).

When the address competition mode is the current monitoring mode and when the obtained request is the target for monitoring in the address competition mode (Yes at Step S202), then the mode managing unit 202 outputs the information about the request and an address confirmation request to the address match determining unit 205. The address match determining unit 205 obtains the address specified in the request from the information about the request. Then, the address match determining unit 205 obtains the target address for monitoring from the target address information 306, and determines whether or not the target address for monitoring matches with the address specified in the request (Step S203).

When the two addresses do not match (No at Step S203), then the address match determining unit 205 notifies the mismatch of addresses to the standby request managing unit 204. Then, the system control proceeds to Step S210.

On the other hand, when the two addresses are matching (Yes at Step S203), then the address match determining unit 205 outputs the information about the request and a standby-request determination request to the standby request managing unit 204. The standby request managing unit 204 refers to the information about the request and determines whether or not the request is a local request (Step S204).

When the request is a local request (Yes at Step S204), then the standby request managing unit 204 and the external request port managing unit 207 perform an external request enable flag setting operation (Step S205). Regarding the external request enable flag setting operation, the detailed explanation is given later.

Then, the standby request managing unit 204 obtains the information about the source from the information about the request. Subsequently, the standby request managing unit 204 checks the value of the completion bit in the field corresponding to the source in the standby request list 305. Then, the standby request managing unit 204 determines whether or not the processing requested by the local request having the same address as the request output from the source is already completed (Step S206).

When the requested processing is already completed (Yes at Step S206), then the standby request managing unit 204 instructs the pipeline control unit 206 to mandatorily abort the inserted request. Then, the pipeline control unit 206 instructs the cache control pipeline 132 to perform mandatory abort processing (Step S207).

On the other hand, when the request processing is not completed (No at Step S206), then the standby request managing unit 204 checks the wait bit in the field corresponding to the source in the standby request list 305 and determines whether or not it is possible to hold a standby request (Step S208).

When the wait bit is set to “0” and when there are not standby requests (Yes at Step S208), then the standby request managing unit 204 sets the wait bit to “1” in the field corresponding to the source in the standby request list 305 and adds a standby request (Step S209).

In that case, the standby request managing unit 204 does not issue a mandatory abort instruction, and the pipeline control unit 206 makes the cache control pipeline 132 perform the normal pipeline processing with respect to the inserted request (Step S210).

On the other hand, when the wait bit is set to “1” and when there are existing standby requests (No at Step S208), then the standby request managing unit 204 refers to the standby request list 305 and determines whether or not the port into which the request is inserted is holding standby requests and does not have the pipeline processing completed therein (Step S211).

When the port into which the request is inserted is holding standby requests and does not have the pipeline processing completed therein (Yes at Step S211), then the system control returns to Step S210. On the other hand, when the port into which the request is inserted is not holding standby requests or has the pipeline processing completed therein (No at Step S211), then the system control returns to Step S207.

Meanwhile, when the request is not a local request (No at Step S204), then the standby request managing unit 204 refers to the information about the request and determines whether or not the request is an external request (Step S212).

When the request is an external request (Yes at Step S212), then the standby request managing unit 204 checks the address match enabled-state information 303 and determines whether or not the monitoring of external requests is enabled (Step S213). When the monitoring of external requests is enabled (Yes at Step S213), then the system control returns to Step S206.

On the other hand, when the monitoring of external requests is not enabled (No at Step S213), then the standby request managing unit 204 and the external request port managing unit 207 perform the external request enable flag setting operation (Step S214). Regarding the external request enable flag setting operation, the detailed explanation is given later. Then, the system control returns to Step S210.

Meanwhile, when the request is not an external request (No at Step S212), the standby request managing unit 204 determines whether or not the request is an order (Step S215). When the request is an order (Yes at Step S215), then the standby request managing unit 204 outputs an instruction to the order port managing unit 208 for setting the order enable flag. The order port managing unit 208 receives input of the instruction for setting the order enable flag, refers to the address match enabled-state information 303, and determines whether or not the monitoring of orders is enabled (Step S216). When the monitoring of orders is enabled (Yes at Step S216), then the system control returns to Step S208.

On the other hand, when the monitoring of orders is not enabled (No at Step S216), then the system control returns to Step S210.

Meanwhile, when the request is not an order (No at Step S215), then the order port managing unit 208 determines whether or not the request is a cache fill request (Step S217). When the request is not a cache fill request (No at Step S217), then the system control returns to Step S210.

On the other hand, when the request is a cache fill request (Yes at Step S217), then the order port managing unit 208 sets the order enable flag to “1” in the address match enabled-state information 303 (Step S218). As a result, the monitoring of orders is enabled.

Subsequently, the order port managing unit 208 initializes the abort counter 209 and sets the counter value to “0” (Step S219). Then, the system control returns to Step S210.

Meanwhile, when the address competition mode is not the current monitoring mode and when the obtained request is not the target for monitoring (No at Step S202), then the mode managing unit 202 determines whether or not the typical resource competition mode is the monitoring mode and whether or not the request is the target for monitoring (Step S220). When the typical resource competition mode is the monitoring mode and when the request is the target for monitoring (Yes at Step S220), then the system control returns to Step S206.

On the other hand, when the typical resource competition mode is not the monitoring mode and when the request is not the target for monitoring (No at Step S220), then the mode managing unit 202 determines whether or not the low-speed resource competition mode is the monitoring mode and whether or not the request is the target for monitoring (Step S221). When the low-speed resource competition mode is the monitoring mode and when the request is the target for monitoring (Yes at Step S221), then the system control returns to Step S206.

On the other hand, when the low-speed resource competition mode is the not monitoring mode and when the request is not the target for monitoring (No at Step S221), then the system control returns to Step S210 because the request is not the target for monitoring.

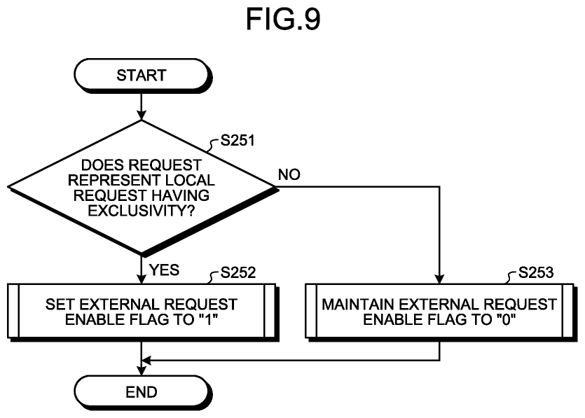

Explained below with reference to FIG. 9 is a flow of the external request enable flag setting operation. FIG. 9 is a flowchart for explaining the external request enable flag setting operation. The flow illustrated in FIG. 9 represents an example of the operations performed at Step S205 illustrated in FIG. 8.

In the operations performed at Step S205, the standby request managing unit 204 uses the address match enabled-state information 303 and determines whether or not the monitoring of external requests is enabled, and ends the external request enable flag setting operation when the monitoring of external requests is enabled. When the monitoring of external requests is not enabled, then the standby request managing unit 204 makes the external request port managing unit 207 perform the following operations. Meanwhile, in the case of the operation at Step S213, the following operations are performed immediately.

The external request port managing unit 207 determines whether or not the inserted request is a local request having exclusivity (Step S251).

When the request is a local request having exclusivity (Yes at Step S251), then the external request port managing unit 207 sets the external request enable flag to “1” in the address match enabled-state information 303 (Step S252). As a result, the monitoring of external requests is enabled.

On the other hand, when the request is not a local request having exclusivity (No at Step S251), then the external request port managing unit 207 maintains the external request enable flag, which represents the address match enabled-state information 303, to “0” (Step S253).

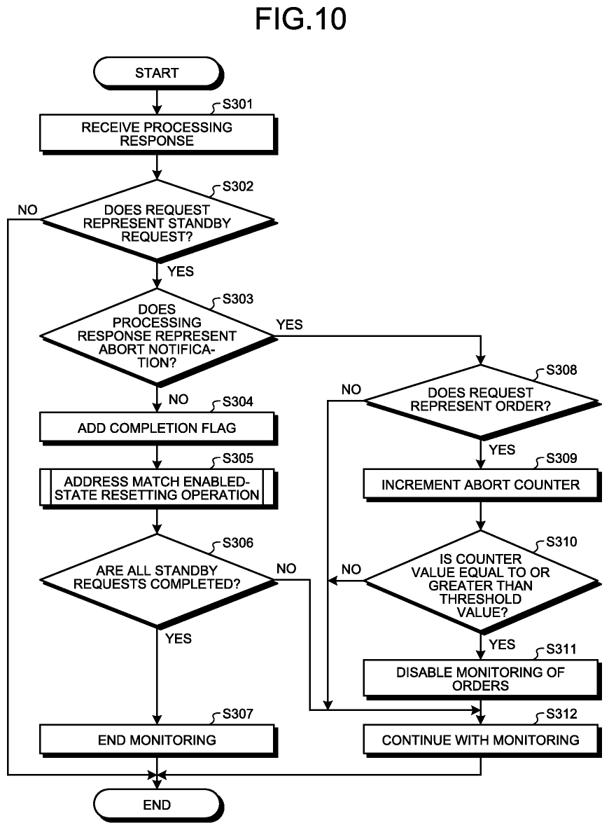

Explained below with reference to FIG. 10 is a flow of the operations performed at the completion of the pipeline processing. FIG. 10 is a flowchart for explaining the operations performed at the completion of the pipeline processing.

The pipeline control unit 206 receives a processing response from the cache control pipeline 132 (Step S301). Then, the pipeline control unit 206 outputs the processing response to the standby request managing unit 204.

The standby request managing unit 204 receives input of the processing response from the pipeline control unit 206. Then, the standby request managing unit 204 obtains the information about the source of the request and the entry ID from the processing response. Then, the standby request managing unit 204 determines whether or not information matching with the information about the source and the entry ID is present in the standby request list 305, that is, determines whether or not the request for which the pipeline processing is completed is a standby request (Step S302). When the request is not a standby request (No at Step S302), then the standby request managing unit 204 ends the operations performed at the completion of the pipeline processing.

On the other hand, when the request is a standby request (Yes at Step S302), then the standby request managing unit 204 determines whether or not the processing response is an abort notification (Step S303).

When the processing response is not an abort notification (No at Step S303), then the standby request managing unit 204 sets the completion bit to “1” in the field corresponding to the request for which the pipeline processing is completed, and adds a completion flag (Step S304). However, when the request is an order, then the standby request managing unit 204 sets the wait bit of the order port to “0” in the standby request list 305 and eliminates the standby request, thereby indicating the completion of the processing of the order.

Subsequently, the standby request managing unit 204, the external request port managing unit 207, and the order port managing unit 208 perform an address match enabled-state information resetting operation (Step S305).

Then, the standby request managing unit 204 determines whether or not the processing requested by all standby requests, which are registered in the standby request list 305, is completed (Step S306). When the processing requested by all standby requests is completed (Yes at Step S306), then the standby request managing unit 204 notifies the overall operation managing unit 201 about the end of monitoring. Then, the overall operation managing unit 201 changes the overall enable flag in the overall operation information 301 to the state indicating that the monitoring is not enabled, and ends the monitoring operation (Step S307).

On the other hand, when the processing requested by any standby request is not yet completed (No at Step S306), then the system control proceeds to Step S312.

Meanwhile, when the processing response indicates abort processing (Yes at Step S303), then the standby request managing unit 204 determines whether or not the request for which the pipeline processing is completed is an order (Step S308). When the request is not an order (No at Step S308), then the system control proceeds to Step S312.

On the other hand, when the request is an order (Yes at Step S308), then the standby request managing unit 204 notifies the order port managing unit 208 about aborting of the order. Upon receiving the notification about aborting of the order processing, the order port managing unit 208 increments the counter value of the abort counter 209 by one (Step S309).

Then, the order port managing unit 208 determines whether or not the counter value of the abort counter 209 is equal to or greater than a threshold value (Step S310). When the counter value of the abort counter 209 is smaller than the threshold value (No at Step S310), the system control proceeds to Step S312.

On the other hand, when the counter value of the abort counter 209 is equal to or greater than the threshold value (Yes at Step S310), then the order port managing unit 208 sets the order enable flag to “0” in the address match enabled-state information 303 so that the monitoring of orders is no more enabled (Step S311).

Subsequently, the constituent elements of the processing sequence adjusting circuit 200 continue with the monitoring (Step S312).

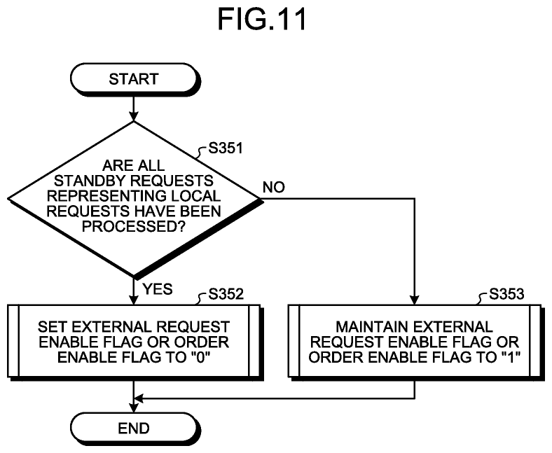

Explained below with reference to FIG. 11 is a flow of the address match enabled-state information resetting operation. FIG. 11 is a flowchart for explaining the address match enabled-state information resetting operation. The flowchart illustrated in FIG. 11 represents an example of the operations performed at Step S305 illustrated in FIG. 10.

The standby request managing unit 204 determines whether or not all standby requests, which represent local requests registered in the standby request list, have been processed (Step S351). When all standby requests representing local requests have been processed (Yes at Step S351); when the corresponding cluster is the home cluster, the external request port managing unit 207 sets the external request enable flag to “0” in the address match enabled-state information 303. However, when the corresponding cluster is not the home cluster, then the order port managing unit 208 sets the order enable flag to “0” (Step S352). As a result, the monitoring of external requests or the monitoring of orders is not enabled.

Meanwhile, when there is any unprocessed standby request representing a local request (No at Step S351); when the corresponding cluster is the home cluster, the external request port managing unit 207 maintains the external request enable flag to “1” in the address match enabled-state information 303 (Step S353). As a result, the monitoring of external requests or the monitoring of orders remains enabled.

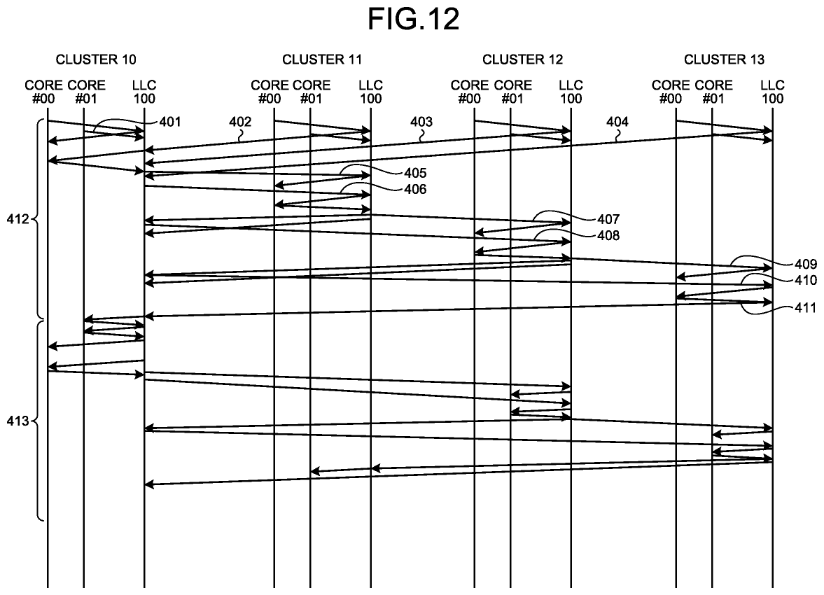

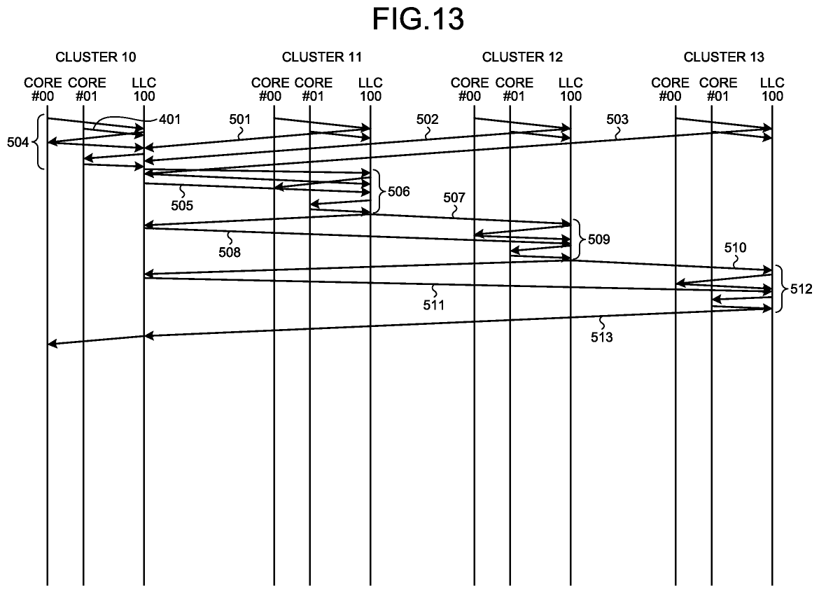

Explained below with reference to FIGS. 12 and 13 is a comparison between the case in which the CPU 1 according to the embodiment is used and the case in which a conventional CPU is used. FIG. 12 is a sequence diagram illustrating an example of the data processing performed in a conventional CPU. FIG. 13 is a sequence diagram illustrating an example of the data processing performed in the CPU according to the embodiment.

Herein, the explanation is given for a case in which the cluster 10 represents the home cluster for the data requested by the request being monitored, and in which the cores #00 and #01 of each of the clusters 10 to 13 issue local requests having the same address.

A local request 401 illustrated in FIG. 12 is issued by the core #01 of the cluster 10 to the corresponding LLC 100 and has the same address as the address of a request issued by the core #00. Subsequently, while the request issued by the core #00 is processed, the LLC 100 of the cluster 10 receives external requests 402 to 404 from the LLCs 100 of the clusters 11 to 13, respectively.

In a conventional CPU, in spite of the incomplete processing of a local request, there are times when an external request is given priority over the local request. In that case, in the cluster 10, the request issued by the core #01 does not get processed, and data illustrated in data transfer 405 is sent to the LLC 100 of the cluster 11.

While the request issued by the corresponding core #00 is processed, the LLC 100 of the cluster 11 receives input of an order 408 with respect to the cluster 12 from the LLC 100 of the cluster 10. Here too, in a conventional CPU, in spite of the incomplete processing of a local request, there are times when an order is given priority over the local request. In that case, the request issued by the core #01 in the cluster 11 does not get processed, and data is sent to the LLC 100 of the cluster 12 as illustrated by data transfer 407.

While the request issued by the corresponding core #00 is processed, the LLC 100 of the cluster 12 receives input of an order 409 with respect to the cluster 13 from the LLC 100 of the cluster 10. Here too, the request issued by the core #01 in the cluster 12 does not get processed, and data is sent to the LLC 100 of the cluster 13 as illustrated by data transfer 409.

While the request issued by the corresponding core #00 is processed, the LLC 100 of the cluster 13 receives input of an order 410 from the LLC 100 of the cluster 10 for returning the data to the home cluster. Here too, the request issued by the core #01 in the cluster 13 does not get processed, and data is sent to the LLC 100 of the cluster 11 as illustrated by data transfer 411.

As a result of the processing explained above, during a time period 412, although the requests issued by the cores #00 are processed in the respective clusters 10 to 13, the requests issued by the cores #01 are not processed and data keeps moving among the clusters 10 and 13.

Subsequently, in a time period 413, in order to process the request of the core #01 of each of the clusters 10 to 13, the data is moved in a sequential manner and the processing is carried out. In this way, in a conventional CPU, the total period of time taken for data processing is a combination of the time period 412 and the time period 413.

In contrast, in the CPU 1 according to the embodiment, the processing is performed as illustrated in FIG. 13. That is, in the cluster 10, the LLC 100 that has received requests from the cores #00 and #01 also receives external requests 501 to 503 from the LLCs 100 of the clusters 11 to 13, respectively. The processing sequence adjusting circuit 200 of the CPU 1 according to the embodiment makes the cache control pipeline 132 process the local requests with priority over external requests and orders, and makes the cache control pipeline 132 process the external requests and the orders only after there are no more standby requests of the local requests.

Hence, after the requests received from the cores #00 and #01 are processed, the LLC 100 of the cluster 10 sends request complete to the cluster 11. That is, the LLC 100 of the cluster 10 sends data to the cluster 11 as a response to the external request 501. As a result, during a time period 504, the processing of the requests issued by the cores #00 and #01 of the cluster 10 is completed. Then, the LLC 100 of the cluster 10 sends an order 505, which instructs transfer of data to the cluster 12 based on the external request 502, to the cluster 11.

In spite of receiving the order 505, the LLC 100 of the cluster 11 continues with the processing of the requests issued by the corresponding cores #00 and #01 and, only after processing the requests issued by the corresponding cores #00 and #01, sends order complete to the cluster 12. That is, the LLC 100 of the cluster 11 sends data to the cluster 12 as illustrated by data transfer 507. As a result, during a time period 506, the processing of the requests issued by the cores #00 and #01 of the cluster 11 is completed.

Subsequently, the LLC 100 of the cluster 10 receives a response about the completion of processing from the cluster 11, and sends an order 508 to the cluster 12. In spite of receiving the order 508, the LLC 100 of the cluster 12 continues with the processing of the requests issued by the corresponding cores #00 and #01 and, only after processing the requests issued by the corresponding cores #00 and #01, sends order complete to the cluster 13. That is, the LLC 100 of the cluster 12 sends data to the cluster 13 as illustrated by data transfer 510. As a result, during a time period 509, the processing of the requests issued by the cores #00 and #01 of the cluster 12 is completed.

Then, the LLC 100 of the cluster 10 receives a response about the completion of processing from the cluster 11, and sends an order 511 to the cluster 13 for returning data to the home cluster. In spite of receiving the order 511, the LLC 100 of the cluster 13 continues with the processing of the requests issued by the corresponding cores #00 and #01 and, only after processing the requests issued by the corresponding cores #00 and #01, sends data back to the cluster 10 as illustrated by data transfer 513. As a result, during a time period 512, the processing of the requests issued by the cores #00 and #01 of the cluster 13 is completed.

As a result of performing the processing explained above, in the CPU 1 according to the embodiment, the data processing is completed within a period of time obtained by adding the time periods 504, 506, 509, 512. In this way, in the CPU 1 according to the embodiment, the local requests are collectively processed in each of the clusters 10 to 13, and then the data is moved. That enables achieving reduction in the overall time for data processing and achieving enhancement in the processing speed.

As described above, in the CPU according to the embodiment, when there are cacheable requests competing for the address, the local requests are processed with priority over the external requests and the orders. As a result, it becomes possible to reduce the latency cost related to the inter-cluster network communication that is until the sharing among all clusters is completed. Moreover, in the CPU according to the embodiment, a request port in which the processing of requests is not completed is given priority over a request port in which the already-issued requests have been processed. As a result, when there is competition among cacheable requests, it becomes possible to perform the processing having a balance among the requests. Hence, it becomes possible to prevent a situation in which a request from a core whose requests have been processed earlier is again accepted even when a request from an unprocessed core is waiting to be processed. Thus, it becomes possible to reduce the occurrence of cores whose processing has not progressed while having particular cores whose processing has progressed.

Moreover, in the CPU according to the embodiment, regarding non-cacheable requests too, a request port in which the processing is not yet completed is given priority over a request port in which the already-issued requests have been processed. As a result, when there is competition among non-cacheable requests, it becomes possible to perform the processing having a balance among the requests. Moreover, in the CPU according to the embodiment, the requests for which the processing takes more time are separated from the other requests; so that, even when there is stagnation of requests for which the processing takes more time, the other requests can still be issued thereby enabling achieving enhancement in the processing efficiency. Moreover, in case there is sequence inequality regarding the requests for which the processing takes particularly more time, then the cores that are overtaken happen to wait for an long period of time. However, in the CPU according to the embodiment, since a balance is achieved in the processing of the requests, it becomes possible to reduce the waiting period for the cores.

Meanwhile, the explanation given above is about the adjustment of the processing sequence of the requests among the clusters in the same CPU. However, the requests received from the clusters of other CPUs can be processed in identical manner to the external requests and the orders, thereby enabling maintaining fairness of the sequence.

According to an aspect of the present invention, when there is competition among the requests, it becomes possible to achieve balance in the processing of the requests and to achieve enhancement in the processing speed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An arithmetic processing device comprising:
an instruction control circuit that decodes an instruction and issues a request;
a plurality of request ports each of which receives and outputs the request;
a control pipeline that
determines whether or not the request output from each of the request ports is processable,
when the request is not processable, performs end processing which includes aborting the request and requesting other request to another request port among the plurality of request ports except the request port which output the request which is not processable, and
when the request is processable, performs pipeline processing which includes requested processing according to the request; and
a sequence adjusting circuit that makes the control pipeline perform the end processing with respect to the request which is output after a processable request from the request port that has already output the processable request with respect to which the control pipeline performed the requested processing.

2. The arithmetic processing device according to claim 1, further comprising arithmetic processing circuits that are disposed in a corresponding manner to some of the request ports and that output the request for processing of memory space to the request ports, wherein
the request ports receive the request output from the arithmetic processing circuits, and
the sequence adjusting circuit makes the control pipeline perform the end processing with respect to the subsequent request that is issued for processing of same address in the memory space as address in the memory space requested in the completion request.

3. The arithmetic processing device according to claim 2, wherein
the arithmetic processing device includes a plurality of arithmetic processing groups each including the arithmetic processing circuits, the request ports, the control pipeline, and the sequence adjusting circuit,
some of the request ports in a first arithmetic processing group receive other-group requests from other arithmetic processing groups, and
when a request is issued by one of the arithmetic processing circuits of the first arithmetic processing group, the sequence adjusting circuit of the first arithmetic processing group makes the control pipeline perform the end processing with respect to the other-group requests received from the other arithmetic processing groups.

4. The arithmetic processing device according to claim 3, wherein, when execution count of the end processing performed with respect to the other-group requests received from the other arithmetic processing groups becomes equal to or greater than a threshold value, the sequence adjusting circuit of the first-type arithmetic processing group terminates the end processing performed by the control pipeline with respect to the other-group requests.

5. The arithmetic processing device according to claim 1, wherein the request is transferred to another processing mechanism via the control pipeline and gets processed in the other processing mechanism.

6. A control method for an arithmetic processing device, comprising:
decoding an instruction, by an instruction control circuit of the arithmetic processing device;
issuing a request based on the decoded instruction, by an instruction control circuit of the arithmetic processing device;
receiving the request by each of a plurality of request ports of the arithmetic professing device;
outputting the request, by each of a plurality of request ports of the arithmetic processing device;
determining whether or not request output from each of the request ports is processable by a control popline of the arithmetic processing device;
when the request is not processable, performing end processing which includes aborting the request and requesting other request to another request ports among the plurality of request ports except the request port which output the request which is not processable; and
when the request is processable, performing pipeline processing which includes requested processing according to the request; and
making the control pipeline perform the end processing with respect to a subsequent request which is output after a possible request from the request port that has already output the possible request with respect to which the control pipeline performed the requested processing by a sequence adjusting circuit of the arithmetic processing device.
